(19) United States
(12) Patent Application Publication
(10) Pub. No.: US 2026/0128877 A1
(43) Pub. Date: May 7, 2026

(54) SECURITY FOR COORDINATED ACCESS POINT (CAP) COMMUNICATIONS

(71) Applicant: QUALCOMM Incorporated, San Diego, CA (US)

(72) Inventors: Abhishek Pramod PATIL, San Diego, CA (US); Giovanni CHISCI, San Diego, CA (US); Alfred ASTERJADHI, San Diego, CA (US); Sai Yiu Duncan HO, San Diego, CA (US); Jouni Kalevi MALINEN, Tuusula (FI); George CHERIAN, San Diego, CA (US); Sanket Sanjay KALAMKAR, San Diego, CA (US); Gaurang NAIK, San Diego, CA (US); Sherief HELWA, San Diego, CA (US)

(21) Appl. No.: 18/936,848

(22) Filed: Nov. 4, 2024

(51) Int. Cl. H04L 9/08

(52) U.S. Cl. CPC H04L 9/088

(57) ABSTRACT

This disclosure provides methods, components, devices and systems for security for coordinated access point (CAP) communications. Some aspects more specifically relate to the establishment of a secret key shared between two or more access points (APs) that are associated with different basic service sets (BSSs) and the use of the shared key to secure pairwise or group-based transmissions between the APs. For example, two or more APs may exchange messages that indicate one or more CAP security-related capabilities of the APs. The APs may establish or otherwise negotiate one or more security schemes for securing the CAP communications between the APs, which may be pairwise CAP communications or group CAP communications. The APs may exchange one or more frames that indicate information for identifying a pairwise or group security key. The APs may exchange CAP communications that are protected in accordance with the established security key.

### TECHNICAL FIELD

This disclosure relates generally to wireless communication and, more specifically, to security for coordinated access point (CAP) communications.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication at a first access point (AP). The method may include transmitting a message that requests or indicates support for establishing coordinated AP (CAP) communications between the first AP and a second AP that is associated with a second basic service set (BSS) different from a first BSS of the first AP, where the message indicates at least one of an ability to establish a secure CAP communication across BSSs or one or more first security parameters for securing the CAP communications across BSSs, receiving one or more frames in accordance with the message and at least one of the ability to establish the secure CAP communication across BSSs or the one or more first security parameters, where the one or more frames indicate one or more second security parameters or a secure security key for the secure CAP communication between the first AP and the second AP, and receiving the secure CAP communication in accordance with security information that is associated with the security key, the security key being established between the first AP and the second AP according to the one or more frames and the one or more first and second security parameters.

Another innovative aspect of the subject matter described in this disclosure can be implemented by a first AP. The first AP may include a processing system that includes processor circuitry and memory circuitry that stores code. The processing system may be configured to cause the first AP to transmit a message that requests or indicates support for establishing CAP communications between the first AP and a second AP that is associated with a second BSS different from a first BSS of the first AP, where the message indicates at least one of an ability to establish a secure CAP communication across BSSs or one or more first security parameters for securing the CAP communications across BSSs, receive one or more frames in accordance with the message and at least one of the ability to establish the secure CAP communication across BSSs or the one or more first security parameters, where the one or more frames indicate one or more second security parameters or a secure security key for the secure CAP communication between the first AP and the second AP, and receive the secure CAP communication in accordance with security information that is associated with the security key, the security key being established between the first AP and the second AP according to the one or more frames and the one or more first and second security parameters.

Another innovative aspect of the subject matter described in this disclosure can be implemented by another first AP. The first AP may include means for transmitting a message that requests or indicates support for establishing CAP communications between the first AP and a second AP that is associated with a second BSS different from a first BSS of the first AP, where the message indicates at least one of an ability to establish a secure CAP communication across BSSs or one or more first security parameters for securing the CAP communications across BSSs, means for receiving one or more frames in accordance with the message and at least one of the ability to establish the secure CAP communication across BSSs or the one or more first security parameters, where the one or more frames indicate one or more second security parameters or a secure security key for the secure CAP communication between the first AP and the second AP, and means for receiving the secure CAP communication in accordance with security information that is associated with the security key, the security key being established between the first AP and the second AP according to the one or more frames and the one or more first and second security parameters.

Another innovative aspect of the subject matter described in this disclosure can be implemented in a non-transitory computer-readable medium storing code for wireless communication at a first AP. The code may include instructions executable by one or more processors to transmit a message that requests or indicates support for establishing CAP communications between the first AP and a second AP that is associated with a second BSS different from a first BSS of the first AP, where the message indicates at least one of an ability to establish a secure CAP communication across BSSs or one or more first security parameters for securing the CAP communications across BSSs, receive one or more frames in accordance with the message and at least one of the ability to establish the secure CAP communication across BSSs or the one or more first security parameters, where the one or more frames indicate one or more second security parameters or a secure security key for the secure CAP communication between the first AP and the second AP, and receive the secure CAP communication in accordance with security information that is associated with the security key, the security key being established between the first AP and the second AP according to the one or more frames and the one or more first and second security parameters.

In some examples of the method, first APs, and the non-transitory computer-readable medium described herein, transmitting the message may include operations, features, means, or instructions for transmitting the message that indicates the one or more first security parameters, where the one or more first security parameters indicate, for each CAP communication scheme of one or more CAP communication schemes supported by the first AP, a respective security scheme supported by the first AP, and where the respective security scheme may be one of a pairwise key establishment, a group key establishment, a message integrity protection, a message encryption, or any combination thereof.

In some examples of the method, the first APs, and the non-transitory computer-readable medium described herein, receiving the one or more frames may include operations, features, means, or instructions for receiving, as part of a handshake procedure between the first AP and the second AP, one or more CAP negotiation frames, one or more CAP notification frames, one or more CAP advertisement frames, or any combination thereof including one or more CAP management fields that indicate information associated with generation of the security key for the secure CAP communication between the first AP and the second AP, where receiving the secure CAP communication may be in accordance with the handshake procedure and the security key.

In some examples of the method, the first APs, and the non-transitory computer-readable medium described herein, the security key includes a CAP group key for secure group CAP transmissions by the second AP to the first AP and one or more other APs, the secure CAP communication includes a group CAP communication, and the security information may be generated in accordance with the CAP group key.

Some examples of the method, the first APs, and the non-transitory computer-readable medium described herein may further include operations, features, means, or instructions for generating, in accordance with a set of multiple fields included before a message integrity check (MIC) field in the secure CAP communication and in accordance with the security key, a first MIC and comparing the first MIC with a second MIC indicated via the MIC field, where the security information includes the second MIC.

An innovative aspect of the subject matter described in this disclosure can be implemented in a method for wireless communication at a second AP. The method may include receiving a message that requests or indicates support for establishing CAP communications between the second AP and a first AP that is associated with a first BSS different from a second BSS of the second AP, where the message indicates at least one of an ability to establish secure CAP communications across BSSs or one or more first security parameters for securing the CAP communications across BSSs, transmitting one or more frames in accordance with the message and at least one of the ability to establish the secure CAP communications across BSSs or the one or more first security parameters, where the one or more frames indicate one or more second security parameters or a security key for the secure CAP communication between the first AP and the second AP, and transmitting the secure CAP communication in accordance with security information that is associated with the security key, the security key being established between the first AP and the second AP according to the one or more frames and the one or more security parameters.

Another innovative aspect of the subject matter described in this disclosure can be implemented by second AP. The second AP may include a processing system that includes processor circuitry and memory circuitry that stores code. The processing system may be configured to cause the second AP to receive a message that requests or indicates support for establishing CAP communications between the second AP and a first AP that is associated with a first BSS different from a second BSS of the second AP, where the message indicates at least one of an ability to establish secure CAP communications across BSSs or one or more first security parameters for securing the CAP communications across BSSs, transmit one or more frames in accordance with the message and at least one of the ability to establish the secure CAP communications across BSSs or the one or more first security parameters, where the one or more frames indicate one or more second security parameters or a security key for the secure CAP communication between the first AP and the second AP, and transmit the secure CAP communication in accordance with security information that is associated with the security key, the security key being established between the first AP and the second AP according to the one or more frames and the one or more security parameters.

Another innovative aspect of the subject matter described in this disclosure can be implemented by another second AP. The second AP may include means for receiving a message that requests or indicates support for establishing CAP communications between the second AP and a first AP that is associated with a first BSS different from a second BSS of the second AP, where the message indicates at least one of an ability to establish secure CAP communications across BSSs or one or more first security parameters for securing the CAP communications across BSSs, means for transmitting one or more frames in accordance with the message and at least one of the ability to establish the secure CAP communications across BSSs or the one or more first security parameters, where the one or more frames indicate one or more second security parameters or a security key for the secure CAP communication between the first AP and the second AP, and means for transmitting the secure CAP communication in accordance with security information that is associated with the security key, the security key being established between the first AP and the second AP according to the one or more frames and the one or more security parameters.

Another innovative aspect of the subject matter described in this disclosure can be implemented in a non-transitory computer-readable medium storing code. The code may include instructions executable by one or more processors to receive a message that requests or indicates support for establishing CAP communications between the second AP and a first AP that is associated with a first BSS different from a second BSS of the second AP, where the message indicates at least one of an ability to establish secure CAP communications across BSSs or one or more first security parameters for securing the CAP communications across BSSs, transmit one or more frames in accordance with the message and at least one of the ability to establish the secure CAP communications across BSSs or the one or more first security parameters, where the one or more frames indicate one or more second security parameters or a security key for the secure CAP communication between the first AP and the second AP, and transmit the secure CAP communication in accordance with security information that is associated with the security key, the security key being established between the first AP and the second AP according to the one or more frames and the one or more security parameters.

In some examples of the method, the second APs, and the non-transitory computer-readable medium described herein, receiving the message may include operations, features, means, or instructions for receiving a message that indicates the one or more first security parameters, where the one or more security parameters indicate one or more CAP communication schemes supported by the first AP and indicate, for each CAP communication scheme of the one or more CAP communication schemes supported by the first AP, a respective security scheme supported by the first AP, and where the respective security scheme may be one of a pairwise key establishment, a group key establishment, a message integrity protection, a message encryption, or any combination thereof.

In some examples of the method, the second APs, and the non-transitory computer-readable medium described herein, transmitting the one or more frames may include operations, features, means, or instructions for transmitting, as part of a handshake procedure between the first AP and the second AP, one or more CAP negotiation frames, one or more CAP notification frames, one or more CAP advertisement frames, or any combination thereof including one or more CAP management fields that indicate information associated with generation of the security key for the secure CAP communication between the first AP and the second AP, where transmitting the secure CAP communication may be in accordance with the handshake procedure and the security key.

In some examples of the method, the second APs, and the non-transitory computer-readable medium described herein, transmitting the one or more frames may include operations, features, means, or instructions for transmitting, to the first AP and one or more other APs via the one or more frames, the security key including a CAP group key for secure group CAP transmissions by the second AP, where the secure CAP communication includes a group CAP communication to the first AP and the one or more other APs, and the security information may be generated in accordance with the CAP group key.

Some examples of the method, the second APs, and the non-transitory computer-readable medium described herein may further include operations, features, means, or instructions for generating, in accordance with a set of multiple fields included before a MIC field in the secure CAP communication and in accordance with the security key, a MIC and transmit the MIC via the MIC field in the secure CAP communication, where the security information includes the MIC.

In some examples of the method, the second APs, and the non-transitory computer-readable medium described herein, encrypt, before transmitting the secure CAP communication, the secure CAP communication in accordance with the security key, where the security information included in the secure CAP communication includes information encrypted in accordance with the security key.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a signaling diagram that supports techniques for coordinated access point (CAP) communications.

FIG. 3 shows an example of a process flow that supports techniques for CAP communications.

FIG. 4 shows a block diagram of an example wireless communication device that supports techniques for CAP communications.

FIG. 5 shows a flowchart illustrating an example process performable by or at a first access point (AP) that supports techniques for CAP communications.

FIG. 6 shows a flowchart illustrating an example process performable by or at a second AP that supports techniques for CAP communications.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks (such as WLANs) may support coordination and scheduling across multiple access points (APs). Such coordinating APs may be non-collocated (such as may operate from a physically separate AP device box) and may be operating on the same operating channel. Such coordinating APs may be within different basic service sets (BSSs), where a BSS may represent an example of an AP and an associated set of stations (STAs) within a coverage area of the AP. The coordinating APs may coordinate according to one or more communication schemes (such as coordinated time division multiplexing (C-TDMA), coordinated restricted target wake time (C-RTWT), coordinated spatial reuse (C-SR), coordinated beamforming (C-BF), one or more other CAP schemes, or any combination thereof). Such coordination may be referred to as coordinated AP (CAP) transmissions or CAP communications or multi-AP (MAP) coordination or MAP transmissions. Some CAP transmissions may involve negotiations between participating APs or may indicate, for example, a portion of a transmission opportunity (TXOP) that is available for use by another AP. The frame exchanges involved during negotiation or TXOP coordination can be among other information that may be vulnerable to malicious attacks if unprotected.

Various aspects relate generally to security mechanisms for protecting CAP communications. Some aspects more specifically relate to establishing a secret key shared between two or more APs that are associated with different BSSs, and using the shared key to secure pairwise or group-based transmissions between the APs (such as securing out-of-BSS transmissions, overlapping BSS (OBSS) transmissions or both). For example, two or more APs may perform a handshake procedure to establish a connection. The APs may exchange one or more messages (such as a discovery message or a capability message, etc.) during the handshake that indicate one or more CAP security-related capabilities of the APs. That is, the APs may establish or otherwise negotiate one or more security schemes for securing the CAP communications between the APs, which may be pairwise CAP communications or group (such as broadcast) CAP communications. The APs may exchange one or more frames that indicate information for determining, selecting, or identifying a pairwise or group security key. A group security key may be indicated via the frames and decrypted. A pairwise security key may be generated at the APs based on an algorithm and information indicated via the frames (such as public key information). The APs may exchange CAP communications that are protected using encryption, message integrity check (MIC), or both in accordance with the established security key. By establishing the pairwise or group security keys, the CAP communications may be secured and less vulnerable to external attacks than non-protected CAP communications.

Particular aspects of the subject matter described in this disclosure can be implemented to realize one or more of the following potential advantages. In some implementations, by securing CAP communications, the described techniques can be used to maintain ultra-high reliability (UHR) communications within a wireless network by supporting coordination between APs while reducing a likelihood of attacks that may disrupt operations between the APs. Additionally, or alternatively, by indicating an AP's capability to support certain security schemes for various CAP protocols via a discovery message or other negation message exchanged during a handshake between two APs, the AP may improve coordination and throughput of communications. The techniques described herein may provide for exchange of frames that support initialization of security keys for secure and protected CAP communications between two or more APs with relatively low overhead and reduced latency as compared with other CAP communication schemes which are not secured. The security techniques may, for example, protect communication between APs that are participating in CAP. The described generation techniques between unassociated devices may provide for the devices to use the generated key for MIC-based integrity protection, or encryption, or both. The described security techniques may protect both management and control frames that are exchanged between APs during discovery, setup, updates, and TXOP-level coordination signaling, among other examples. Additionally, or alternatively, the key generation information and security information (such as the MIC) may be conveyed via one or more fields within signaling (such as the MIC field) while maintaining a signaling format that is compatible with other communication types and features.

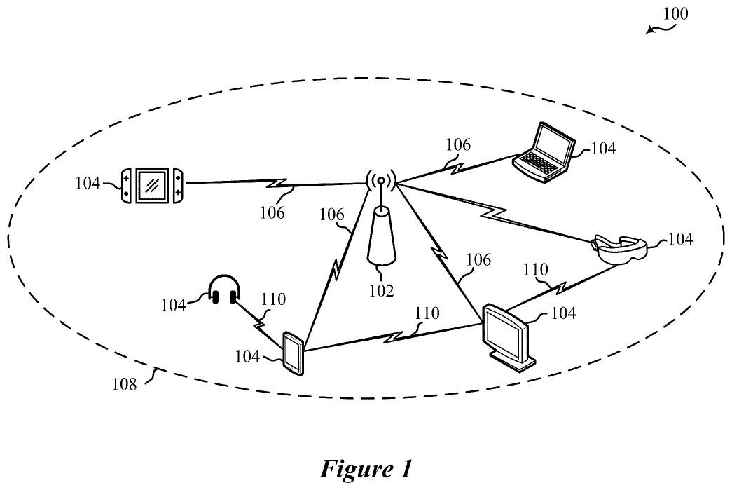

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) 802.11bq study group. In some other implementations, the wireless communication network 100 can be an example of a cellular radio access network (RAN), such as a 5G or 6G RAN that implements one or more cellular protocols such as those specified in one or more 3GPP standards. In some other implementations, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other implementations, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHZ, 45 GHz, or 60 GHZ bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some implementations, ad hoc networks may be implemented within a larger network such as the wireless communication network 100. In such implementations, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHZ), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some implementations, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a transmission opportunity (TXOP) on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some implementations, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some implementations, the M-Primary channel may be used for beaconing and serving legacy client devices and an O-Primary channel may be specifically used by non-legacy (such as UHR-or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some implementations in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other implementations, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other implementations, signals for transmission may be generated by four or more different transmit chains of the wireless communication device, each having a bandwidth of 80 MHz.

In noncontiguous implementations, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some implementations, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mm Wave” or “mm W”) band (such as a frequency band between 30 GHz and 300 GHz, such as a 60 GHz frequency band). A wireless communication system supporting such mmWave communications (such as AP 102 and STAs 104 in wireless communication network 100) may use integrated mm Wave (IMMW) techniques to support operations in these frequency bands. To manage the relatively high attenuation losses and other path losses associated with the mm Wave band, the AP 102 and STAs 104 may transmit and receive directional communications via beamforming procedures. To select or otherwise generate directional beams in the mm Wave band, a wireless communication device may perform beam sweeping, searching and training operations, which may involve various training and feedback reporting packet sequences. In some wireless communication systems, a mm Wave link supports data communications while a sub7 link may be used for management and control information signaling to support the mm Wave communications. For example, a STA 104 may first associate with an AP 102 to establish a sub7 link, and thereafter, perform beam searching and training in the mm Wave band to establish a mm Wave link for the communication of data. In such implementations, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mm Wave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mm Wave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mm Wave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mm Wave frequencies. Particular RF and analog designs, such as RF front end designs, antenna integration designs, and conversion architecture designs, may be implemented in APs 102 and STAs 104 to support mm Wave operation.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QOS) parameters. For example, existing technology (such as IEEE 802.11ax standard amendment protocols) supports the use of up to 1024-quadrature amplitude modulation (QAM), where a modulated symbol carries 10 bits. To further improve peak data rate, each of the AP 102 or the STA 104 may employ use of 4096-QAM (also referred to as “4 k QAM”), which enables a modulated symbol to carry 12 bits. 4 k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 μs per OFDM symbol). The AP 102 or the STA 104 using 4096-QAM may enable a 20% increase in data rate compared to 1024-QAM given the same coding rate, thereby allowing users to obtain higher transmission efficiency.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some implementations, the control frame and fields within the MAC header of the data or management frames, or both, also may be secured either via encryption or via an integrity check (such as by generating a message integrity check (MIC) for one or more relevant fields.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP (CAP) TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some implementations of such TDMA techniques, each portion of a plurality of portions of the TXOP includes a set of time resources that do not overlap with any time resources of any other portion of the plurality of portions of the TXOP. In such implementations, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some implementations of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a CAP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some implementations in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some implementations, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific implementations, the sharing AP may transmit a CAP TXOP indication (CTI) frame to other APs that indicates time and frequency of resources of the TXOP that can be shared. The sharing AP may select one or more candidate APs upon receiving a CAP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other implementations, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

The CAP communication framework may support one or more CAP transmission schemes including, for example, coordinated TDMA (C-TDMA), coordinated restricted target wake time (C-RTWT), coordinated spatial reuse (C-SR), coordinated beamforming (C-BF), one or more other CAP schemes, or any combination thereof. Some security enhancements for secure in-BSS transmissions may include, for example, control frame protection (CFP), MAC header protection (MHP), enhancements to group addressed frames, or any combination thereof. However, out-of-BSS transmissions, overlapping BSS (OBSS) transmissions or both, including CAP transmissions, may not be protected, in some implementations, which may result in CAP transmissions being relatively vulnerable to attacks. Out-of-BSS may include OBSS, or other BSS schemes, among other examples of communications associated with CAP between APs 102 associated with different BSSs.

In some implementations, two APs 102 may be coordinating for a feature, such as coordinating to share a TXOP, or otherwise negotiating one or more communication parameters, and a malicious device may attack or otherwise intercept the communication between the two APs 102. In some implementations, a first AP 102 may share a TXOP with a second AP 102. A malicious device may impersonate the second AP 102 (such as using the MAC address of the second AP 102) to transmit an end frame to relinquish the shared portion of the TXOP early thus causing potential collisions and disruptions in communications by the APs 102. In some implementations, a first AP 102 may send, to a second AP 102, a frame that indicates MAC addresses of one or more of clients of the first AP 102 to coordinate interference measurements with the second AP 102. A malicious device may decode the frame and obtain information about the identities of the clients, which the malicious device may use for subsequent attacks. In some implementations, a first AP 102 and a second AP 102 may negotiate a schedule for the first AP 102 that is to be protected (such as the second AP 102 should terminate a TXOP before such a scheduled boundary). A malicious device may impersonate the first AP 102 and modify the agreement to shift the schedule such that the second AP 102 may transmit over the scheduled time for the first AP 102, among other examples. CAP communications may thereby be susceptible to attack.

Techniques, systems, and devices described herein relate to mechanisms for protecting CAP signaling to protect frames carrying critical information between APs 102. Such protection may reduce a probability of attacks on CAP communications, thereby further improving ultra-high reliability (UHR) communications, among other examples. Two or more APs 102 may establish a pairwise key that is used for protection of communications between the two or more APs 102. Additionally, or alternatively, a group key may be established to protect one or more frames that are addressed to a group of coordinating APs 102. The group key may be shared with intended participating APs 102 in a secure manner. Such CAP protection schemes may be performed in addition to or as an alternative to protection schemes for other in-BSS communications.

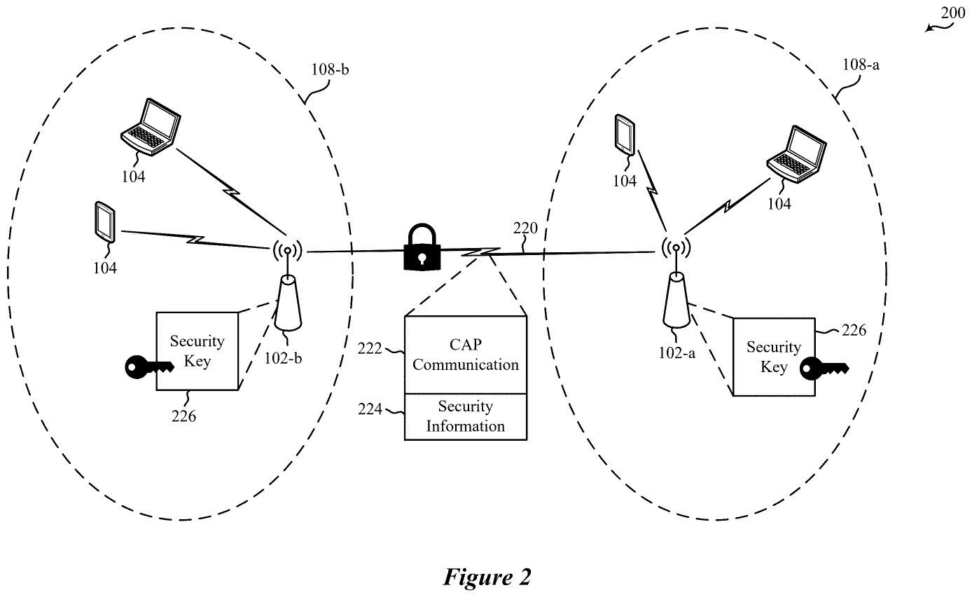

FIG. 2 shows an example of a signaling diagram 200 that supports techniques for CAP communications. The signaling diagram 200 may implement or be implemented by aspects of the wireless communication network 100. For example, the signaling diagram illustrates an AP 102-a associated with a first coverage area 108-a including multiple STAs 104 that communicate with the AP 102-a and an AP 102-b associated with a second coverage area 108-b including multiple STAs 104 that communicate with the AP 102-b. The APs 102, the STAs 104, and the coverage areas 108 may each represent examples of corresponding devices and coverage areas as described with reference to FIG. 1. In this example, the AP 102-a and the AP 102-b may establish secure CAP communications 222 via a communication link 220 that extends between coverage areas 108 and corresponding BSSs.

In the example of the signaling diagram 200, the AP 102-a may support a first coverage area 108-a (such as BSA) including or otherwise associated with a first BSS (such as including the AP 102-a and each of the STAs 104 connected to the AP 102-a within the coverage area 108-a). The AP 102-b may similarly support a second coverage area 108-b including or otherwise associated with a second BSS (such as including the AP 102-b and each of the STAs 104 connected to the AP 102-b within the coverage area 108-b). As described with reference to FIG. 1, the AP 102-a and the AP 102-b may establish a coordinated connection via a communication link 220, which may be an example of a wireless communication link, a Wi-Fi link, or some other type of link. The AP 102-a and the AP 102-b may perform a handshake procedure to establish the connection via the communication link 220 for CAP communications 222.

To improve CAP security and reliability, the AP 102-a and the AP 102-b may support security mechanisms for securing the CAP communications 222. For example, mechanisms for an AP 102 to establish a common key are defined herein, where the common key may include a pairwise key for protecting pairwise CAP communications 222 (such as AP2AP communications) between two APs 102 or a group key for protecting group-addressed frames sent by a coordinating AP 102 to a group of other participating APs 102. The described techniques may thereby support authentication, by coordinating APs 102, of each other's messages using the established security key(s) 226, may define containers and signaling for conveying security parameters associated with an AP 102, and may support coexistence between in-BSS security schemes and out-of-BSS security schemes, among other examples. Out-of-BSS as described herein may include OBSS, or other BSS schemes, among other examples of communications associated with CAP between APs 102 associated with different BSSs. For example, a CAP communication 222 may include security information 224 that secures the CAP communication 222. The security information 224 may be, for example, a form of encryption of the data included in the CAP communication 222, a MIC, or some other security information.

Techniques for establishing a secure pairwise key for the CAP communications 222 between the AP 102-a and the AP 102-b may include using a peer key protocol (such as AP PeerKey) to exchange frames and generate a pairwise key, to use a pre-association security negotiation (PASN) protocol to generate the pairwise key, or any combination thereof. In some implementations, the AP 102-a and the AP 102-b may exchange one or more frames that indicate one or more security parameters for the CAP communications 222, the secure pairwise key for the CAP communications 222, or any combination thereof. For example, the AP 102-a and the AP 102-b may exchange one or more public key frames in accordance with the AP PeerKey protocol to generate a pairwise master key (PMK) for use in securing the CAP communications 222 (such as the secure pairwise key described herein). The exchange of public key frames to establish a shared key between two APs 102 as described herein may be different from signaling to authenticate an AP 102. For example, the AP 102-a may not authenticate or authorize the AP 102-b, but the AP 102-a may still verify messages received from the AP 102-b using the shared pairwise key. The AP 102-a and the AP 102-b may thereby exchange the one or more public key frames in addition to one or more CAP negotiation frames as part of a handshake procedure to establish a connection between the AP 102-a and the AP 102-b. The APs 102 described herein may thereby support aspects or an extension of the AP PeerKey protocol from use in mesh networks to use for PMK establishing across BSSs and corresponding coverage areas 108 for the CAP communications 222.

In some implementations, exchanging the public frames may include the AP 102-a (such as an initiating AP 102) transmitting a request for the public key of the AP 102-b (such as a peer AP 102). The AP 102-a may send the request via a public key frame with the public key frame usage filed set to “Request.” The AP 102-b may respond to the request from the AP 102-a by transmitting a public key frame with the public key frame usage filed set to “Response,” indicating that an acceptable group value was sent by the AP 102-a via the request or set to “NAK,” indicating that the group value sent by the AP 102-a was unacceptable. If the AP 102-b sends a successful response with a corresponding public key, the AP 102-a may, in some implementations, transmit a responsive public key frame with the usage field set to “Response.” The AP 102-a and the AP 102-b may generate a PMK based on the exchanged public key(s) and may terminate the AP PeerKey protocol. The PMK may be referred to as a security key 226 herein and may be generated in accordance with one or more hash functions or other algorithms (such as finite cyclic groups).

In some implementations, the PeerKey protocol may be vulnerable to an attack if multiple instances of the PeerKey protocol are performed by an AP 102. A rogue device may, therefore, hijack a session between the AP 102-a and the AP 102-b, for example, by impersonating the AP 102-b and tricking the AP 102-a into establishing a new session key with the rogue device. To reduce probability of such attacks, the described techniques provide for an AP PeerKey protocol extension, in which each AP 102 may include a secret that is known only to the transmitting AP 102. For example, the AP 102-a may include a secret in the public key frame that the AP 102-a transmits to the AP 102-b as part of the PeerKey protocol. The secret may be known to the AP 102-a, and the AP 102-a may provide the secret to the peer AP 102-b during an initial setup (such as a very first time a security key is established between the AP 102-a and the AP 102-b). The AP 102-b and the AP 102-a may both use the same secret in subsequent key exchanges. The secret would have validity until the CAP operation is negotiated between the two APs 102, at which time the secret may become invalid. The described extensions for using an exchanged secret to further protect the PeerKey protocol may be applicable to other protocols and mechanisms for deriving a shared key between any quantity of two or more APs 102 or other unassociated devices (such as devices that do not share a trusted third party).

In some implementations, to exchange the one or more frames for the generation of the security key 226, the AP 102-a and the AP 102-b may exchange one or more CAP negotiation frames that include one or more Public Key frame fields for generation of the security key 226. For example, instead of exchanging both the public key frames and the CAP negotiation frames, the AP 102-a and the AP 102-b may combine the frames. The AP 102-a and the AP 102-b may thereby exchange CAP negotiation frames that include the public key information along with one or more other parameters associated with the CAP negotiations. In such implementations, the AP 102-a and the AP 102-b may generate the PMK, which may be available for use after the negotiation between the AP 102-a and the AP 102-b is successful. In such implementations, the AP 102-a and the AP 102-b may convey per-feature negotiations via CAP management frames, which also can be used for generating the key(s). For example, a negotiation for a given feature may include a feature-specific element in the CAP frame container. An AP 102 may introduce additional element to the frame for the key generation. The APs 102 may thus generate unique pairwise keys (such as multiple security keys 226) for different CAP communication protocols or schemes. For example, the AP 102-a and the AP 102-b may establish a first pairwise security key 226 to use for authenticating c-TDMA communications and a second pairwise security key 226 to use for authenticating c-BF communications, or the like.

In some implementations, the AP 102-a and the AP 102-b may use a PASN protocol to generate the pairwise security key 226. The PASN protocol may include exchanging three PASN frames between the AP 102-a and the AP 102-b. The AP 102-a may send a first PASN frame may to initiate the PASN authentication with the AP 102-b (such as assuming both the AP 102-a and the AP 102-b are PASN-capable). The AP 102-a may indicate, via the first PASN frame, a public key of the AP 102-a, one or more PASN parameters, one or more PMKs, or any combination thereof. The AP 102-b may process the first PASN frame and respond with a second PASN frame that indicates a public key of the AP 102-b, one or more PASN parameters, one or more PMKs, or any combination thereof. The second PASN frame may be protected via integrity protection, in some implementations. The AP 102-a may receive and process the second PASN frame and may respond with a third PASN frame that is integrity protected and confirms the PASN procedure. The AP 102-a and the AP 102-b may thereby generate the pairwise security key 226 based on the PMKs and PASN parameters exchanged as part of the PASN protocol.

The APs 102 may support group CAP communications. For example, the AP 102-a may transmit the CAP communication 222 to a group of participating APs 102, including the AP 102-b and one or more other APs 102 (such as via a broadcast), where the CAP communication 222 may be addressed to the multiple target receiving APs 102. Such group communications may be subject to attacks by intruders. Accordingly, the techniques described herein provide for protection of group CAP communications 222 by establishing a group security key.

In some implementations, the group security key may be generated by each transmitting AP 102 individually, and may be different from an in-BSS key for secure in-BSS including in-BSS control frame protection. For example, each AP 102 may generate a CAP group key and provide the CAP group key in a secure manner to the other APs 102. The AP 102-a may, for example, generate a secure CAP group key. Before transmitting a group CAP transmission to the AP 102-b and one or more other APs 102, the AP 102-a may transmit one or more frames to the target receiving APs 102. The one or more frames may include the group security key, and may be encrypted according to some pairwise key or otherwise integrity protected using a MIC based on the pairwise key established between the AP 102-a and each of the target receiving APs 102. For example, after the AP 102-a and the AP 102-b establish the pairwise key, the AP 102-a may send its group security key to the AP 102-b via a secure message for the AP 102-b to use for authenticating subsequent group communications from the AP 102-a. The secure message may be encrypted using the pairwise key so that the group security key is not provided in plain text. The sharing of the group security key from the AP 102-a or other transmitting APs 102 may be performed relatively infrequently, and may not be time critical. Accordingly, the encryption of the message may not affect performance of the devices.

Additionally, or alternatively, the group security key for group CAP communications may be the same as a group key that is used for in-BSS and direct AP-to-AP security (such as a coordinated integrity group temporal key (c-IGTK), which may be a hierarchy consisting of a single key to provide integrity protection for group addressed robust Management frames). For example, an AP 102 may send a broadcast key to multiple STAs 104 within the coverage area 108 of the AP 102. The key may be used for protection of in-BSS transmissions from the AP 102. In some implementations, such a key for control frame protection may be reused for CAP group communication protection. The security key may be sent, by the AP 102-a for example, to one or more other intended target APs 102 using secure messaging. For example, the AP 102-a may re-use the in-BSS group key and send the in-BSS group key to the AP 102-b via an encrypted message. The AP 102-b may decrypt the message using a pairwise security key 226 between the AP 102-a and the AP 102-b. Re-using the c-IGTK for CAP group communications may reduce overhead and processing by, for example, reducing a quantity of keys to be generated and stored and by, for example, reducing overhead when a frame involves both in-BSS communications and CAP communications 222, among other examples.

The AP 102-a and the AP 102-b may thereby establish, in accordance with the techniques described herein, a pairwise security key 226, a group security key, or both for the CAP communications 222. Once the key(s) is established, the AP 102-a and the AP 102-b may use the security key 226 to protect subsequent CAP communications 222 with associated security information 224 that is generated according to one or more protection schemes, including an integrity check scheme, an encryption scheme, or both. The AP 102-a and the AP 102-b may use the pairwise security key 226 for protecting any individually addressed control frames, management frames, or data frames exchanged between the AP 102-a and the AP 102-b. Similarly, the AP 102-a may use the group security key for protecting any group addressed control frames, management frames, or data frames carrying CAP information or meant to facilitate CAP operation that are sent by the AP 102-a to a group of other APs 102.

In some implementations, the APs 102 may protect the CAP communications 222 via integrity check. The integrity check may be applicable to control frames, management frames, or both. For CAP frames that are exchanged one-to-one between two APs 102 (such as from the AP 102-a to the AP 102-b, or vice versa), the pairwise security key 226 established between the APs 102 may be used for the integrity protection. Such frames may include, for example, control frames, data frames, management frames, or any combination thereof. An AP 102 may protect a control frame using integrity protection by generating a MIC across all or a portion of contents of the control frame using the generated pairwise security key 226 or the generated group security key. An AP 102 may similarly protect a data frame or a management frames using integrity protection by generating a MIC across all or a portion of the content within the corresponding frame, or by generating a MIC across a header portion of the frame using the generated pairwise security key 226 or the generated group security key. For CAP frames that are addressed to multiple APs 102 (such as initial control frame (ICF) sent to a broadcast address), the transmitting AP 102 may generate the MIC based on the group key of the transmitting AP 102. For example, if the AP 102-a transmits a group frame to the AP 102-b and one or more other APs 102, the AP 102-a may generate a MIC based on the group key of the AP 102-a and may send the MIC via the group frame (such as via the security information 224). The receiving APs 102 may have received an indication of the group key from the AP 102-a, and may use the group key to decode and verify the MIC. In some implementations, a response frame to the group frame (such as an initial control response (ICR)) may include a MIC generated according to a pairwise security key 226 between the responding AP 102 and the AP 102-a for integrity protection, which may further improve security and reliability of the CAP communications 222.

Additionally, or alternatively, the APs 102 may protect the CAP communications 222 via encryption and using the key(s) established between APs 102. For example, frames that are exchanged between APs 102 and carry critical information fields may be encrypted using the pairwise security key 226 or the group security key (such as based on whether the frames are individually addressed or group addressed frames, respectively). The transmitting AP 102 may perform the encryption in accordance with the respective key, such that a receiving AP 102 may decrypt the frames if the receiving AP 102 is the correct intended receiver, but an intruding device may not decrypt the frame. The security information 224 may include or otherwise be associated with the encrypted data, which may not be in plain text format.

The described CAP protection schemes may be applied, by one or more transmitting APs 102, to frames that include the CAP communications 222 (such as out-of-BSS communications) as well as in-BSS communications. For example, an AP 102 may transmit a buffer status report poll (BSRP) frame to announce C-TDMA scheduling, and may involve both in-BSS STAs 104 as well as other APs 102 that are out-of-BSS. The AP 102-a may, for example, transmit a frame that includes information for the AP 102-b in a different BSS as well as information for the STAs 104 within the coverage area 108-b and the same BSS as the AP 102-a. Such a frame may include separate security information 224 for both the in-BSS communications and the CAP communications 222 (such as MIC and security parameters for both in-BSS and out-of-BSS control frame protection). This may involve two or more different key identifiers (IDs), two or more packet numbers, and two or more MICs, or any combination thereof.

In some implementations, an in-BSS and out-of-BSS frame may include a protection indication (such as one or more bits) that indicates whether the security information 224 within the frame applies to the CAP communications 222, the in-BSS communications, or both (such as the protection bit may apply to in-BSS control frame protection). For example, if the protection indication is set to a first value (such as bit=0) and a field carrying security information 224 (such as a user info field carrying security parameters) is present in the frame, the in-BSS STAs 104 may ignore the security information 224. That is, if the protection indication is set to the first value, the frame may be secured (such as integrity checked or encrypted) for the CAP communications 222 using a shared CAP key, but may not be secured in-BSS (such as in-BSS protection may be disabled). The STAs 104 within the same coverage area 108 as the transmitting AP 102 may thereby receive and read the frame without security. If the protection indication is set to a second value (such as bit=1), this may indicate that both in-BSS and out-of-BSS protection is enabled. In such implementations, the in-BSS STAs 104 may reuse the same security information 224 used by the out-of-BSS APs 102, or the frame may include a second field that conveys second security information 224 for the in-BSS communications. If out-of-BSS protection is disabled and in-BSS protection is enabled, the protection indication may be set to the second value, and the frame may include a second protection indication that is configured to indicate whether out-of-BSS protection is enabled or disabled.

In some implementations, a common information field within the frame may carry an in-BSS key ID and a second key ID for the CAP communications 222 (such as a one-bit key for AP-to-AP control frame protection) may be carried within a user information field within the frame, or both of the in-BSS and CAP key IDs may be conveyed via a user information field (such as dedicated fields for each key). A key ID may indicate which temporal key, of two or more temporal keys that are generated, is used to protect the frame. For example, if a PMK is established between two or more APs 102 or other devices (such as STAs 104), the PMK may be used to generate two or more temporal keys. The key ID may indicate which of the temporal keys is used for in-BSS communications or out-of-BSS communications. In such implementations, a value of the in-BSS key ID may indicate which (of two or more) temporal keys is used to protect the frame for in-BSS communications, and a value of the out-of-BSS key ID may indicate which (of two or more) temporal keys is used to protect the frame for out-of-BSS communications. In some implementations, the same key ID value may apply to both in-BSS and CAP security. In such implementations, if either the in-BSS security or the CAP security needs a rekeying (such as to switch temporal keys based on a new PMK), both schemes may be rekeyed because the key ID reference may change.

A frame involving both in-BSS and out-of-BSS protection may include separate security containers for carrying the security information 224. For example, each packet number and each MIC may be conveyed via a separate container. The separate containers may be security containers carried as special user information fields (such as identified based on an AID12 field) or within padding within a protected trigger frame (such as identified based on a control ID field). In some implementations, the security containers may be a combination of a special user information field for in-BSS security parameters and padding within a protected trigger frame for out-of-BSS security parameters. For multi-STA block ACKs (MBAs), the separate containers may be conveyed as per AID-traffic ID (TID) tuples in a protected MBA. The tuples may be separated and identified based on combinations of values in AID and TID fields. For example, a unique AID and TID combination may identify CAP control frame protection parameters and a second AID and TID combination may identify in-BSS control frame protection parameters.

A receiving device may identify the various separated security containers within a combined frame in accordance with unique ID values, an identification field, an order of the fields in the frame, or any combination thereof. For example, the frame may include some unique (such as special) values that identify user information fields that carry security parameters for in-BSS control frame protection vs. user information fields that carry security parameters for CAP control frame protection. The unique values may be, for example, AID12 values, per-AID TID values, control ID values, or any combination thereof. Additionally, or alternatively, the same AID12, AID-TID, and control ID values may be present for in-BSS and CAP security parameters, but a field within each security container may identify whether the security container applies to in-BSS or CAP security. If the value of the field is a first value (such as zero), this may indicate that the security container applies to in-BSS communications and if the value of the field is a second value (such as one), this may indicate that the security container applies to CAP communications. The frame may thereby include sufficient bits for an extra field within each separate security container. In some other implementations, the same AID12, AID-TID, and control ID values may be present for in-BSS and CAP security parameters, but an order of the security containers within the frame may identify which security container is which. For example, the APs 102 and STAs 104 may be configured to interpret a first security container in a given fame as related to in-BSS security parameters and a subsequent security container in the given frame as related to CAP security parameters, or vice versa.

The APs 102 and the STAs 104 may operate in accordance with one or more protocols that support the use of protected frames including both in-BSS and out-of-BSS communications. The protocols may be configured at the devices, defined in a standard, indicated via control signaling, or any combination thereof. The protocols may include, for example, a rule for specifying which portions of the frame are used for MIC generation. In some implementations, the fields preceding (such as up to) the MIC field in the frame may be inputs to the MIC generation in addition to the security key 226. These fields may include, for example, the security container (such as user information field, padding, or both) that contains the security parameters, a packet number field, other fields, or any combination thereof. The field carrying the packet number also may be protected by the MIC. Any fields after the MIC field may not be considered for MIC generation. Accordingly, if the in-BSS MIC field precedes the out-of-BSS MIC field within the frame, the out-of-BSS MIC field and other related fields may not be considered for MIC generation by associated STAs 104 that receive the frame. Similarly, any fields after the out-of-BSS MIC field may not be considered for MIC generation by coordinating APs 102. However, the out-of-BSS MIC generation may include the in-BSS fields and corresponding MIC, in some implementations in which the in-BSS MIC field precedes the out-of-BSS MIC.

In some implementations, the one or more protocols for the use of shared protected frames including in-BSS and out-of-BSS communications may include a mechanism for indicating (such as implicitly or explicitly) the start or end of the user information and per AID-TID fields carrying the security parameters for a given communication scheme. Such an indication may help identify a start of another set of security parameters, such as security parameters for the CAP communications 222, which may improve coordination between devices for MIC generation and reduce latency by reducing a quantity of unnecessary fields a receiving device may decode. For example, a receiving STA 104 may refrain from decoding the fields for out-of-BSS security based on such an indication. In some implementations, one or more different AID values may be defined to indicate a start, an end, or both, of a given set of security parameters. Additionally, or alternatively, a length field may be included in a first user information field or a first per AID-TID security field. The length field may indicate a length (such as a quantity of bits, a quantity of fields, or the like) of the corresponding set of security parameters. The length field may be useful for scenarios in which the security parameters for the in-BSS communications and the security parameters for the out-of-BSS communications have different lengths. In some other implementations, the frame may include a field (such as a bit field) that indicates whether there are more security parameter fields to follow the current field for the same security category. A final field for a given security category may be set to zero, for example, to indicate an end of the security parameters for the corresponding category.

In some systems, the Packet numbers (PN) used for frames that include both in-BSS and out-of-BSS communications may be from a same shared packet number space or from separate packet number spaces, in some implementations described herein. The packet numbers may monotonically increase for different packets. For frames shared for both in-BSS and out-of-BSS communications, the checks for packet number and other security features may be performed by different receivers. Accordingly, a same packet number may be reused within a same frame. For example, a c-TDMA scheduling announcement frame addressed to in-BSS STAs 104 and out-of-BSS APs 102, the same packet number may be used for both in-BSS and out-of-BSS MIC generation without violating security considerations. The shared packet number may save space within the frame (such as up to six octets of overhead may be removed due to the absence of a repeated packet number). The fields carrying out-of-BSS security parameters may thereby not include a field for the packet number.

In some implementations described herein, a coordinating AP 102, such as the AP 102-a, for example, may send a message to one or more STAs 104 associated with another AP 102 with whom the AP 102-a is coordinating. For example, the AP 102-a may trigger one or more of the STAs 104 within the coverage area 108-b associated with the AP 102-b with whom the AP 102-a is coordinating. The STAs 104 belonging to the neighboring AP 102-b may be able to verify that the trigger frame is indeed from a trusted AP 102 (such as verify whether the AP 102-a is a trusted AP) with whom the AP 102-b associated with the STAs 104 is coordinating. Such a verification may be supported by each AP 102 identifying all neighboring APs 102 with whom the AP 102 is performing CAP. For example, the AP 102-a may indicate, to each STA 104 within the coverage area 108-a (such as UHR STAs 104), information that identifies each of the neighboring APs 102, including the AP 102-b, for example, with which the AP 102-a is performing CAP. The AP 102-b may similarly indicate, to each STA 104 within the coverage area 108-b (such as UHR STAs 104), information that identifies each of the neighboring APs 102, including the AP 102-a, for example, with which the AP 102-b is performing CAP. The information conveyed to the associated STAs 104 from a given AP 102 may include a group key of each of the coordinating neighbor APs 102. The group key may be the same as or different from what the coordinating neighbor AP 102 is using for AP-to-AP security.

Each STA 104 may receive and store the information indicating which neighboring APs 102 are coordinating with a serving AP 102 for the given STA 104 and the group key for each of the trusted APs 102. When a coordinating AP 102 polls the STA 104, the coordinating AP 102 may include, in the trigger frame, a field (such as a user information field) that carries one or more out-of-BSS security parameters. In some implementations, the trigger frame may additionally include a field or some other mechanism (such as an order in which the field appears) to identify which field(s) carry the out-of-BSS security parameters. The STA 104, when polled by the neighboring AP 102, may verify that the AP 102 is one of the APs 102 identified as a coordinating AP 102 and that the MIC in the out-of-BSS security field matches the locally computed MIC for that AP 102. For example, the AP 102-a may poll a STA 104 within the coverage area 108-b of the AP 102-b. The AP 102-a may include out-of-BSS security parameters within the trigger frame. The STA 104 may determine whether the group key indicated via the trigger frame is one of the group keys indicated to the STA 104 by the AP 102-b as being a trusted group key of a trusted neighboring AP 102. The STA 104 may further compute a local MIC using the group key, and may compare the local MIC with a MIC indicated via the out-of-BSS security fields in the trigger frame. If the MIC is correct and the AP 102-a is a trusted neighboring AP 102, the STA 104 may verify the frame and engage with the AP 102-a.

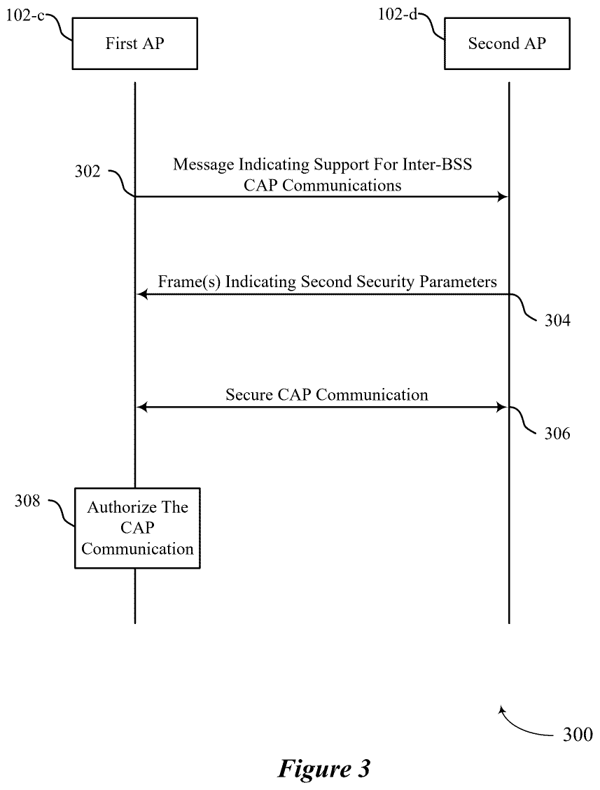

The AP 102-a and the AP 102-b may thereby establish a connection via the communication link 220, may establish a security key 226 (such as a pairwise key for AP-to-AP CAP communications and a group key for group CAP communications), and may verify or otherwise authenticate any CAP communications based on the established security key 226 and one or more security schemes. In some implementations, the APs 102 may exchange one or more messages as part of an initial negotiation and handshake operation. Such messages may include or otherwise indicate security capabilities of the APs 102, which may be described in further detail elsewhere herein, including with reference to FIG. 3.

FIG. 3 shows an example of a process flow 300 that supports security for CAP communications. The process flow 300 may implement or be implemented by aspects of the wireless communication network 100 and the signaling diagram 200 as described with reference to FIGS. 1 and 2. The process flow 300 includes a first AP 102-c and a second AP 102-d, which may represent examples of corresponding devices as described with reference to FIGS. 1 and 2.

In the following description of the process flow 300, the operations between the first AP 102-c and the second AP 102-d may be transmitted in a different order than the example order shown, or the operations performed by the first AP 102-c and the second AP 102-d may be performed in different orders or at different times. Some operations also may be omitted from the process flow 300, and other operations may be added to the process flow 300.

At 302, the first AP 102-c may transmit, to the second AP 102-d, a message that requests or indicates support for establishing CAP communications between the first AP 102-c and the second AP 102-d that is associated with a second BSS different from a first BSS of the first AP 102-c (such as inter-BSS CAP communications). The message may indicate at least one of an ability to establish a secure CAP communication across BSSs, one or more first security parameters for securing the CAP communications across BSSs, or both. In some implementations, the AP 102-c may transmit the message as part of an initial handshake or negotiation procedure between the AP 102-c and the AP 102-d.

For example, the AP 102-c may send a discovery message to the AP 102-d to indicate capabilities of the AP 102-c (such as an ability of the AP 102-c to establish a secure CAP communication) link, or a frame that initiates establishment of the secure CAP communication link, or some other message associated with a connection between the APs 102. The AP 102-c may signal, via the message, a capability of the AP 102-c to perform CAP security schemes described herein, a request to use security features for multi-AP communications, or both. The message (such as a discovery message) may indicate, via the one or more first security parameters, a capability of the AP 102-c to support one or more CAP communication schemes. The CAP communication schemes may include, for example, a pairwise key establishment, a group key establishment, an integrity protection scheme, a message encryption scheme, or any combination thereof, as described in further detail elsewhere herein, including with reference to FIG. 2. The AP 102-c may thereby indicate the capability or set of capabilities for CAP security supported by the AP 102-c via a discovery message sent to the AP 102-d, or some other initial trigger frame to establish communications with the AP 102-d. For example, the message may be a broadcast management frame that includes a bitmap or some other field for indicating capabilities of the AP 102-c, including supported CAP communication schemes (such as c-TDMA, c-SR, c-BF, c-RTWT, or the like), and supported CAP security schemes (such as pairwise key, group key, encryption, integrity protection, or the like).

In some implementations, after a discovery message is sent from the AP 102-c to the AP 102-d (such as or instead of the discovery message), the AP 102-d may respond with a frame that initiates establishment of the secure CAP communication link, and the AP 102-c and the AP 102-d may perform a handshake procedure to establish the secure link. Additionally, or alternatively, the AP 102-d may transmit the discovery message and the AP 102-c may initiate the handshake, or any combination. The handshake procedure may include an exchange of one or more frames (such as management frames) between the AP 102-c and the AP 102-d to negotiate one or more per-feature agreements for the secure CAP communications between the AP 102-c and the AP 102-d. For example, the AP 102-c and the AP 102-d may exchange one or more management frames that include per-feature elements to negotiate agreements. The response from the AP 102-d may, for example, indicate one or more security parameters that are supported by the AP 102-d, one or more security parameters that are not supported by the AP 102-d, or any combination thereof. The AP 102-c and the AP 102-d may thereby exchange one or more management frames during the per-feature negotiation handshake (such as the handshake to establish a c-SR agreement between the AP 102-c and the AP 102-d) to indicate that one or more multi-AP security sub features, such as pairwise key and encryption of frames, or other sub features, are required for CAP communications. Upon completion of the negotiation, if a sub feature is indicated as “required” by one of the AP 102-c or the AP 102-d and agreed upon during the negotiation, the agreement may be valid, and the AP 102-c or the AP 102-d may start using the feature after fulfilling the operations for multi-AP security establishment.

The AP 102-c and the AP 102-d may thereby establish a secure connection for secure CAP communications and may negotiate security parameters for securing one or more different types of CAP communications exchanged via the secure connection.

At 304, the AP 102-d may transmit, to the AP 102-c in accordance with the message(s) exchanged at 302, one or more frames that indicate one or more second security parameters, a secure key for the secure CAP communication between the AP 102-c and the AP 102-d, or both. In some implementations, the AP 102-c may respond by transmitting one or more frames to the AP 102-c.

In some implementations, the one or more frames may include one or more public key frames exchanged in accordance with an AP PeerKey protocol, as described with reference to FIG. 2. For example, the AP 102-c and the AP 102-d may perform an AP PeerKey protocol to generate and establish a security key (such as a PMK) for the secure CAP communications. The one or more frames may include public key information (such as one or more second security parameters) configured to facilitate the generation of a shared security key by each of the AP 102-c and the AP 102-d.

Additionally, or alternatively, the one or more frames may include one or more CAP negotiation frames. For example, during the handshake procedure, the AP 102-c and the AP 102-d may exchange one or more CAP negotiation frames that include one or more fields of public key information (such as one or more second security parameters) configured to facilitate the generation of a shared security key by each of the AP 102-c and the AP 102-d. In such implementations, the AP 102-c and the AP 102-d may establish and generate the security key per feature (such as per CAP communication scheme), as described with reference to FIG. 2.

In some other implementations, the one or more frames may include one or more frames exchanged between the AP 102-c and the AP 102-d as part of a PASN protocol. The information (such as one or more second security parameters) conveyed via the one or more PASN frames may facilitate the generation of a shared security key by each of the AP 102-c and the AP 102-d. In each of these implementations, the shared security key may be a pairwise key for securing pairwise CAP communications between the AP 102-c and the AP 102-d.

In some implementations, the one or more frames may be associated with a group key of the AP 102-d. For example, the AP 102-d may transmit the one or more frames in a secure manner (such as encrypted) to indicate the group key of the AP 102-d. As described with reference to FIG. 2, the AP 102-d may uniquely generate the group key for CAP communications, or may reuse a group key for in-BSS communications by the AP 102-d as the group key. The AP 102-d may convey the group key to the AP 102-c via a secured message using encryption based on a secure pairwise key established between the AP 102-c and the AP 102-d. The group key may thereby be sent after establishment of the pairwise key, in some implementations. Although not pictured, it is to be understood that the AP 102-c may additionally, or alternatively, transmit one or more secured frames to indicate a group key of the AP 102-c to the AP 102-d. The group keys may include keys for securing group-addressed CAP transmissions.

At 306, the AP 102-d may transmit a secure CAP communication to the AP 102-c in accordance with security information associated with the security key established between the AP 102-c and the AP 102-d according to the frames exchanged at 304 and the first and second security parameters (such as the negotiated security parameters and the security key). The secure CAP communication may be secured in accordance with an integrity check, encryption, or both. For example, the AP 102-d may generate a MIC based on the security key, and may include the MIC in a MIC field of the secure CAP transmission. Additionally, or alternatively, the AP 102-d may encrypt the secure CAP communication using an encryption algorithm that is based on the security key.

The AP 102-d may transmit the secure CAP communication individually to the AP 102-c as a pairwise communication, and may secure the communication using the secure pairwise key established between the AP 102-d and the AP 102-c. Additionally, or alternatively, the AP 102-d may transmit the secure CAP communication to a group of APs 102 including the AP 102-c (such as may be group addressed). In such implementations, the AP 102-d may secure the CAP communication using the secure group key previously indicated from the AP 102-d to the AP 102-c. In some implementations, the secure CAP communication may be conveyed via a frame associated with (such as including) both in-BSS communications and the secure CAP communication. In such implementations, the frame may include one or more security containers for separately securing each of the in-BSS and CAP communications, a protection indication or other field or bit for indicating which secure container applies to which communication type, or any combination thereof.

At 308, in some implementations, the AP 102-c may authorize the secure CAP communication using the security key and the one or more security parameters. For example, if the secure CAP communication includes a MIC field, the AP 102-c may generate, using all fields that precede the MIC field for CAP communications, a MIC at the AP 102-c, and may compare the MIC with the MIC indicated via the MIC field in the secure CAP communication. If the MICs do not match, the AP 102-c may determine that the CAP communication is not valid. If the MICs do match, the AP 102-c may determine that the CAP communication is secure and valid from a trusted cooperating AP.

Additionally, or alternatively, if the secure CAP communication is encrypted, the AP 102-c may decrypt the secure CAP communication using the security key established between the AP 102-c and the AP 102-d (such as a pairwise or group key). If the AP 102-c is unable to decrypt the message based on the security key, the AP 102-c may determine that the communication is invalid. If the AP 102-c is able to successfully decrypt the communication, the AP 102-c may determine that the CAP communication is secure and valid from a trusted cooperating AP. The AP 102-c may coordinate with the AP 102-d based on authorizing the CAP communication. In some implementations, the AP 102-c may similarly transmit one or more secure CAP communications to the AP 102-d using the security protocols and parameters described herein.

In some implementations, the AP 102-c, the AP 102-d, or both may change a MAC address during operation. For example, the APs 102-c and 102-d may randomly change or otherwise randomize MAC addresses so that they are not trackable, which may improve privacy and security. In such implementations, the AP 102 that changes the MAC address may initiate a rekeying operation with the other AP 102. For example, if the AP 102-c changes a MAC address, the AP 102-c may initiate a new rekeying operation with the AP 102-d to account for the new MAC address of the AP 102-c. The rekeying operation may be initiated by resending the message at 302 to initiate support, or by exchanging one or more frames that include key information, or both. Additionally, or alternatively, if the AP 102-c and the AP 102-d support MAC address randomization, the AP 102-c and the AP 102-d may setup a schedule when to rekey in accordance with the new MAC addresses. For example, the AP 102-c and the AP 102-d may setup a schedule for periodic rekeying or rekeying at some defined interval, or the like. The AP 102-c and the AP 102-d may, in some implementations, exchange a security phrase or value during an initial connection setup that may be used as a token to confirm the AP identities during subsequent rekeying operations.

The described techniques may thereby provide for out-of-BSS CAP communications exchanged between two APs associated with different BSSs to be secured, which may reduce a likelihood of attacks and improve reliability and throughput of the CAP communications, among other examples.

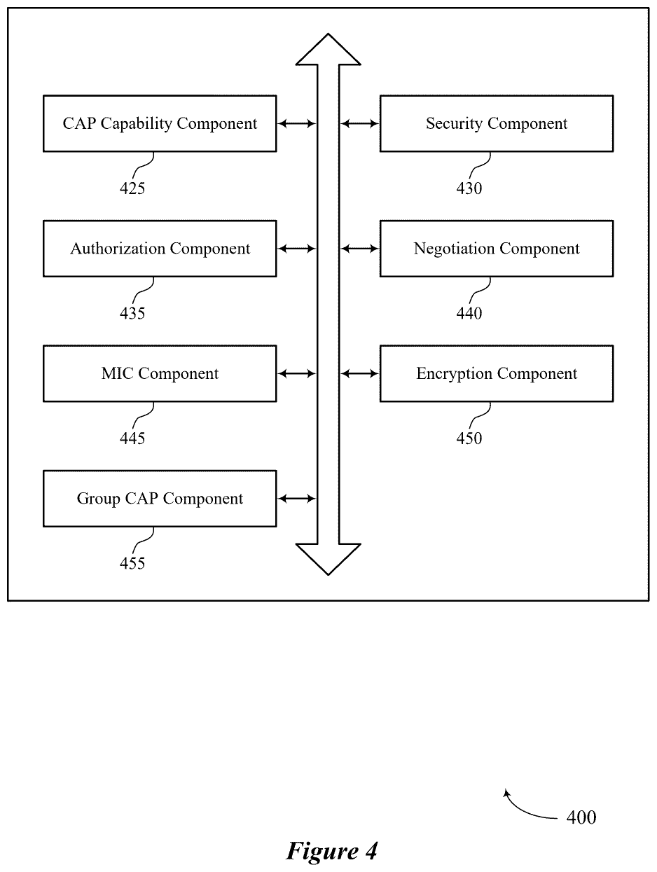

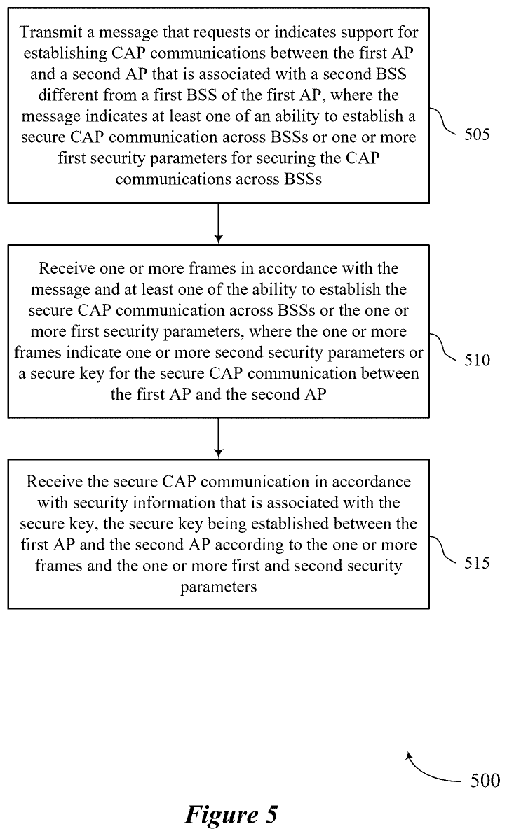

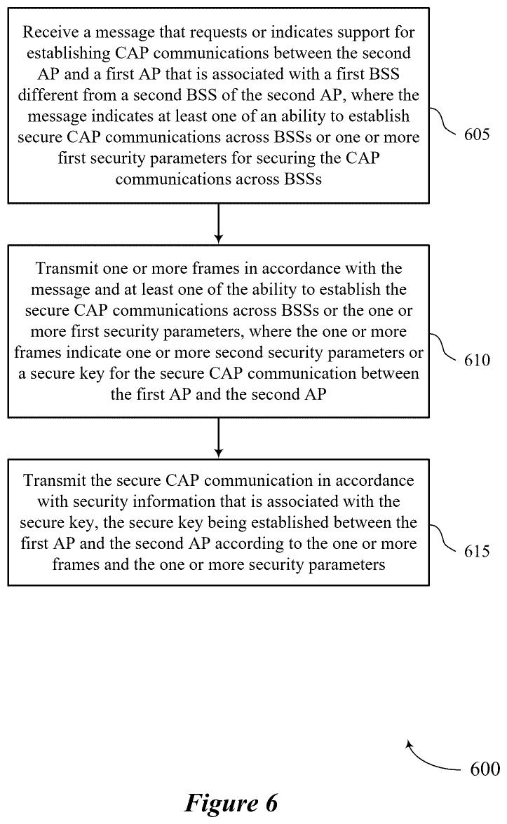

FIG. 4 shows a block diagram of an example wireless communication device 400 that supports security for CAP communications. In some implementations, the wireless communication device 400 is configured to perform the processes 500 and 600 described with reference to FIGS. 5 and 6, respectively. The wireless communication device 400 may include one or more chips, SoCs, chipsets, packages, components or devices that individually or collectively constitute or include a processing system. The processing system may interface with other components of the wireless communication device 400, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 400 may transmit the information output from the chip. In such an example, the second interface may refer to an interface between the processing system of the chip and a reception component, such that the wireless communication device 400 may receive information that is then passed to the processing system. In some such implementations, the first interface also may obtain information, such as from the transmission component, and the second interface also may output information, such as to the reception component.

The processing system of the wireless communication device 400 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 400 can be configurable or configured for use in an AP, such as the AP 102 described with reference to FIG. 1. In some other implementations, the wireless communication device 400 can be an AP that includes such a processing system and other components including multiple antennas. The wireless communication device 400 is capable of transmitting and receiving wireless communications in the form of, for example, wireless packets. For example, the wireless communication device 400 can be configurable or configured to transmit and receive packets in the form of physical layer PPDUs and MPDUs conforming to one or more of the IEEE 802.11 family of wireless communication protocol standards. In some other implementations, the wireless communication device 400 can be configurable or configured to transmit and receive signals and communications conforming to one or more 3GPP specifications including those for 5G NR or 6G. In some implementations, the wireless communication device 400 also includes or can be coupled with one or more application processors which may be further coupled with one or more other memories. In some implementations, the wireless communication device 400 further includes at least one external network interface coupled with the processing system that enables communication with a core network or backhaul network that enables the wireless communication device 400 to gain access to external networks including the Internet.

The wireless communication device 400 includes a CAP capability component 425, a security component 430, an authorization component 435, a negotiation component 440, a MIC component 445, an encryption component 450, and a group CAP component 455. Portions of one or more of the CAP capability component 425, the security component 430, the authorization component 435, the negotiation component 440, the MIC component 445, the encryption component 450, and the group CAP component 455 may be implemented at least in part in hardware or firmware. For example, one or more of the CAP capability component 425, the security component 430, the authorization component 435, the negotiation component 440, the MIC component 445, the encryption component 450, and the group CAP component 455 may be implemented at least in part by at least a processor or a modem. In some implementations, portions of one or more of the CAP capability component 425, the security component 430, the authorization component 435, the negotiation component 440, the MIC component 445, the encryption component 450, and the group CAP component 455 may be implemented at least in part by a processor and software in the form of processor-executable code stored in memory.

The wireless communication device 400 may support wireless communications in accordance with examples as disclosed herein. The CAP capability component 425 is configurable or configured to transmit a message that requests or indicates support for establishing coordinated AP (CAP) communications between the first AP and a second AP that is associated with a second basic service set (BSS) different from a first BSS of the first AP, where the message indicates at least one of an ability to establish a secure CAP communication across BSSs or one or more first security parameters for securing the CAP communications across BSSs. The security component 430 is configurable or configured to receive one or more frames in accordance with the message and at least one of the ability to establish the secure CAP communication across BSSs or the one or more first security parameters, where the one or more frames indicate one or more second security parameters or a security key for the secure CAP communication between the first AP and the second AP. The authorization component 435 is configurable or configured to receive the secure CAP communication in accordance with security information that is associated with the security key, the security key being established between the first AP and the second AP according to the one or more frames and the one or more first and second security parameters.

In some implementations, to support transmitting the message, the CAP capability component 425 is configurable or configured to transmit the message that indicates the one or more first security parameters, where the one or more first security parameters indicate, for each CAP communication scheme of one or more CAP communication schemes supported by the first AP, a respective security scheme supported by the first AP, and where the respective security scheme is one of a pairwise key establishment, a group key establishment, a message integrity protection, a message encryption, or any combination thereof.

In some implementations, to support receiving the one or more frames, the security component 430 is configurable or configured to receive, in accordance with an AP PeerKey protocol, one or more public key frames from the second AP, where the security key for the secure CAP communication between the first AP and the second AP is generated in accordance with information indicated via the one or more public key frames.

In some implementations, to support receiving the one or more frames, the negotiation component 440 is configurable or configured to receive, as part of a handshake procedure between the first AP and the second AP, one or more CAP negotiation frames, one or more CAP notification frames, one or more CAP advertisement frames, or any combination thereof including one or more CAP management fields that indicate information associated with generation of the security key for the secure CAP communication between the first AP and the second AP, where receiving the secure CAP communication is in accordance with the handshake procedure and the security key.

In some implementations, to support receiving the one or more frames, the security component 430 is configurable or configured to receive, in accordance with a pre-association security negotiation (PASN) protocol, one or more PASN frames from the second AP, where the security key for the secure CAP communication between the first AP and the second AP is generated in accordance with information indicated via the one or more PASN frames.

In some implementations, the security key includes a CAP group key for secure group CAP transmissions by the second AP to the first AP and one or more other APs. In some implementations, the secure CAP communication includes a group CAP communication. In some implementations, the security information is generated in accordance with the CAP group key.

In some implementations, the MIC component 445 is configurable or configured to generate, in accordance with a set of multiple fields included before a message integrity check (MIC) field in the secure CAP communication and in accordance with the security key, a first MIC. In some implementations, the MIC component 445 is configurable or configured to compare the first MIC with a second MIC indicated via the MIC field, where the security information includes the second MIC.

In some implementations, the encryption component 450 is configurable or configured to decrypt the secure CAP communication in accordance with the security key, where the security information included in the secure CAP communication includes information encrypted in accordance with the security key.

In some implementations, to support receiving the secure CAP communication, the security component 430 is configurable or configured to receive a frame associated with in-BSS communications and the CAP communications, the frame including a protection indication that indicates whether the security information applies to the CAP communications or not, where verification, by the first AP, of the secure CAP communication, is performed in accordance with the protection indication.

In some implementations, to support receiving the secure CAP communication, the security component 430 is configurable or configured to receive, via the secure CAP communication, one or more first fields that convey the security information for verifying a first portion of the secure CAP communication directed to the first AP. In some implementations, to support receiving the secure CAP communication, the security component 430 is configurable or configured to receive, via the secure CAP communication, one or more second fields that convey second security information for verifying a second portion of the secure CAP communication including in-BSS communications by the second AP.

Additionally, or alternatively, the wireless communication device 400 may support wireless communications in accordance with examples as disclosed herein. In some implementations, the CAP capability component 425 is configurable or configured to receive a message that requests or indicates support for establishing CAP communications between the second AP and a first AP that is associated with a first BSS different from a second BSS of the second AP, where the message indicates at least one of an ability to establish secure CAP communications across BSSs or one or more first security parameters for securing the CAP communications across BSSs. In some implementations, the security component 430 is configurable or configured to transmit one or more frames in accordance with the message and at least one of the ability to establish the secure CAP communications across BSSs or the one or more first security parameters, where the one or more frames indicate one or more second security parameters or a security key for the secure CAP communication between the first AP and the second AP. In some implementations, the authorization component 435 is configurable or configured to transmit the secure CAP communication in accordance with security information that is associated with the security key, the security key being established between the first AP and the second AP according to the one or more frames and the one or more security parameters.

In some implementations, to support receiving the message, the CAP capability component 425 is configurable or configured to receive a message that indicates the one or more first security parameters, where the one or more security parameters indicate one or more CAP communication schemes supported by the first AP and indicate, for each CAP communication scheme of the one or more CAP communication schemes supported by the first AP, a respective security scheme supported by the first AP, and where the respective security scheme is one of a pairwise key establishment, a group key establishment, a message integrity protection, a message encryption, or any combination thereof.

In some implementations, to support transmitting the one or more frames, the security component 430 is configurable or configured to transmit, in accordance with an AP PeerKey protocol, one or more public key frames to the first AP, where the security key for the secure CAP communication between the first AP and the second AP is generated in accordance with information indicated via the one or more public key frames.

In some implementations, to support transmitting the one or more frames, the negotiation component 440 is configurable or configured to transmit, as part of a handshake procedure between the first AP and the second AP, one or more CAP negotiation frames, one or more CAP notification frames, one or more CAP advertisement frames, or any combination thereof including one or more CAP management fields that indicate information associated with generation of the security key for the secure CAP communication between the first AP and the second AP, where transmitting the secure CAP communication is in accordance with the handshake procedure and the security key.

In some implementations, to support transmitting the one or more frames, the security component 430 is configurable or configured to transmit, in accordance with a PASN protocol, one or more PASN frames to the first AP, where the security key for the secure CAP communication between the first AP and the second AP is generated in accordance with information indicated via the one or more PASN frames.

In some implementations, to support transmitting the one or more frames, the group CAP component 455 is configurable or configured to transmit, to the first AP and one or more other APs via the one or more frames, the security key including a CAP group key for secure group CAP transmissions by the second AP, where the secure CAP communication includes a group CAP communication to the first AP and the one or more other APs, and the security information is generated in accordance with the CAP group key.

In some implementations, the MIC component 445 is configurable or configured to generate, in accordance with a set of multiple fields included before a MIC field in the secure CAP communication and in accordance with the security key, a MIC. In some implementations, the MIC component 445 is configurable or configured to transmit the MIC via the MIC field in the secure CAP communication, where the security information includes the MIC.

In some implementations, the encryption component 450 is configurable or configured to encrypt, before transmitting the secure CAP communication, the secure CAP communication in accordance with the security key, where the security information included in the secure CAP communication includes information encrypted in accordance with the security key.

In some implementations, to support transmitting the secure CAP communication, the security component 430 is configurable or configured to transmit a frame associated with in-BSS communications and the CAP communications, the frame including a protection indication that indicates whether the security information applies to the CAP communications or not, where verification, by the first AP, of the secure CAP communication, is performed in accordance with the protection indication.

In some implementations, to support transmitting the secure CAP communication, the security component 430 is configurable or configured to transmit, via the secure CAP communication, one or more first fields that convey the security information for verifying a first portion of the secure CAP communication. In some implementations, to support transmitting the secure CAP communication, the security component 430 is configurable or configured to transmit, via the secure CAP communication, one or more second fields that convey second security information for verifying a second portion of the secure CAP communication including in-BSS communications by the second AP.

FIG. 5 shows a flowchart illustrating an example process 500 performable by or at a first AP that supports security for CAP communications. The operations of the process 500 may be implemented by a first AP or its components as described herein. For example, the process 500 may be performed by a wireless communication device, such as the wireless communication device 400 described with reference to FIG. 4, operating as or within a wireless AP. In some implementations, the process 500 may be performed by a wireless AP, such as one of the APs 102 described with reference to FIG. 1.

In some implementations, in 505, the first AP may transmit a message that requests or indicates support for establishing CAP communications between the first AP and a second AP that is associated with a second BSS different from a first BSS of the first AP, where the message indicates at least one of an ability to establish a secure CAP communication across BSSs or one or more first security parameters for securing the CAP communications across BSSs. The operations of 505 may be performed in accordance with examples as disclosed herein. In some implementations, aspects of the operations of 505 may be performed by a CAP capability component 425 as described with reference to FIG. 4.

In some implementations, in 510, the first AP may receive one or more frames in accordance with the message and at least one of the ability to establish the secure CAP communication across BSSs or the one or more first security parameters, where the one or more frames indicate one or more second security parameters or a security key for the secure CAP communication between the first AP and the second AP. The operations of 510 may be performed in accordance with examples as disclosed herein. In some implementations, aspects of the operations of 510 may be performed by a security component 430 as described with reference to FIG. 4.

In some implementations, in 515, the first AP may receive the secure CAP communication in accordance with security information that is associated with the security key, the security key being established between the first AP and the second AP according to the one or more frames and the one or more first and second security parameters. The operations of 515 may be performed in accordance with examples as disclosed herein. In some implementations, aspects of the operations of 515 may be performed by an authorization component 435 as described with reference to FIG. 4.

FIG. 6 shows a flowchart illustrating an example process 600 performable by or at a second AP that supports security for CAP communications. The operations of the process 600 may be implemented by a second AP or its components as described herein. For example, the process 600 may be performed by a wireless communication device, such as the wireless communication device 400 described with reference to FIG. 4, operating as or within a wireless AP. In some implementations, the process 600 may be performed by a wireless AP, such as one of the APs 102 described with reference to FIG. 1.

In some implementations, in 605, the second AP may receive a message that requests or indicates support for establishing CAP communications between the second AP and a first AP that is associated with a first BSS different from a second BSS of the second AP, where the message indicates at least one of an ability to establish secure CAP communications across BSSs or one or more first security parameters for securing the CAP communications across BSSs. The operations of 605 may be performed in accordance with examples as disclosed herein. In some implementations, aspects of the operations of 605 may be performed by a CAP capability component 425 as described with reference to FIG. 4.

In some implementations, in 610, the second AP may transmit one or more frames in accordance with the message and at least one of the ability to establish the secure CAP communications across BSSs or the one or more first security parameters, where the one or more frames indicate one or more second security parameters or a security key for the secure CAP communication between the first AP and the second AP. The operations of 610 may be performed in accordance with examples as disclosed herein. In some implementations, aspects of the operations of 610 may be performed by a security component 430 as described with reference to FIG. 4.

In some implementations, in 615, the second AP may transmit the secure CAP communication in accordance with security information that is associated with the security key, the security key being established between the first AP and the second AP according to the one or more frames and the one or more security parameters. The operations of 615 may be performed in accordance with examples as disclosed herein. In some implementations, aspects of the operations of 615 may be performed by an authorization component 435 as described with reference to FIG. 4.

Implementation examples are described in the following numbered clauses:

Aspect 1: A method for wireless communications by a first AP, including: transmitting a message that requests or indicates support for establishing CAP communications between the first AP and a second AP that is associated with a second BSS different from a first BSS of the first AP, where the message indicates at least one of an ability to establish a secure CAP communication across BSSs or one or more first security parameters for securing the CAP communications across BSSs; receiving one or more frames in accordance with the message and at least one of the ability to establish the secure CAP communication across BSSs or the one or more first security parameters, where the one or more frames indicate one or more second security parameters or a security key for the secure CAP communication between the first AP and the second AP; and receiving the secure CAP communication in accordance with security information that is associated with the security key, the security key being established between the first AP and the second AP according to the one or more frames and the one or more first and second security parameters.

Aspect 2: The method of aspect 1, where transmitting the message includes: transmitting the message that indicates the one or more first security parameters, where the one or more first security parameters indicate, for each CAP communication scheme of one or more CAP communication schemes supported by the first AP, a respective security scheme supported by the first AP, and where the respective security scheme is one of a pairwise key establishment, a group key establishment, a message integrity protection, a message encryption, or any combination thereof.

Aspect 3: The method of any of aspects 1 through 2, where receiving the one or more frames includes: receiving, in accordance with an AP PeerKey protocol, one or more public key frames from the second AP, where the security key for the secure CAP communication between the first AP and the second AP is generated in accordance with information indicated via the one or more public key frames.

Aspect 4: The method of any of aspects 1 through 3, where receiving the one or more frames includes: receiving, as part of a handshake procedure between the first AP and the second AP, one or more CAP negotiation frames, one or more CAP notification frames, one or more CAP advertisement frames, or any combination thereof including one or more CAP management fields that indicate information associated with generation of the security key for the secure CAP communication between the first AP and the second AP, where receiving the secure CAP communication is in accordance with the handshake procedure and the security key.

Aspect 5: The method of any of aspects 1 through 2, where receiving the one or more frames includes: receiving, in accordance with a PASN protocol, one or more PASN frames from the second AP, where the security key for the secure CAP communication between the first AP and the second AP is generated in accordance with information indicated via the one or more PASN frames.

Aspect 6: The method of any of aspects 1 through 2, where the security key includes a CAP group key for secure group CAP transmissions by the second AP to the first AP and one or more other APs; the secure CAP communication includes a group CAP communication; and the security information is generated in accordance with the CAP group key.

Aspect 7: The method of any of aspects 1 through 6, further including: generating, in accordance with a plurality of fields included before a MIC field in the secure CAP communication and in accordance with the security key, a first MIC; and comparing the first MIC with a second MIC indicated via the MIC field, where the security information includes the second MIC.

Aspect 8: The method of any of aspects 1 through 6, further including: decrypting the secure CAP communication in accordance with the security key, where the security information included in the secure CAP communication includes information encrypted in accordance with the security key.

Aspect 9: The method of any of aspects 1 through 8, where receiving the secure CAP communication includes: receiving a frame associated with in-BSS communications and the CAP communications, the frame including a protection indication that indicates whether the security information applies to the CAP communications or not, where verification, by the first AP, of the secure CAP communication, is performed in accordance with the protection indication.

Aspect 10: The method of any of aspects 1 through 9, where receiving the secure CAP communication includes: receiving, via the secure CAP communication, one or more first fields that convey the security information for verifying a first portion of the secure CAP communication directed to the first AP; and receiving, via the secure CAP communication, one or more second fields that convey second security information for verifying a second portion of the secure CAP communication including in-BSS communications by the second AP

Aspect 11: A method for wireless communications by a second AP, including: receiving a message that requests or indicates support for establishing CAP communications between the second AP and a first AP that is associated with a first BSS different from a second BSS of the second AP, where the message indicates at least one of an ability to establish secure CAP communications across BSSs or one or more first security parameters for securing the CAP communications across BSSs; transmitting one or more frames in accordance with the message and at least one of the ability to establish the secure CAP communications across BSSs or the one or more first security parameters, where the one or more frames indicate one or more second security parameters or a security key for the secure CAP communication between the first AP and the second AP; and transmitting the secure CAP communication in accordance with security information that is associated with the security key, the security key being established between the first AP and the second AP according to the one or more frames and the one or more security parameters.

Aspect 12: The method of aspect 11, where receiving the message includes: receiving a message that indicates the one or more first security parameters, where the one or more security parameters indicate one or more CAP communication schemes supported by the first AP and indicate, for each CAP communication scheme of the one or more CAP communication schemes supported by the first AP, a respective security scheme supported by the first AP, and where the respective security scheme is one of a pairwise key establishment, a group key establishment, a message integrity protection, a message encryption, or any combination thereof.

Aspect 13: The method of any of aspects 11 through 12, where transmitting the one or more frames includes: transmitting, in accordance with an AP PeerKey protocol, one or more public key frames to the first AP, where the security key for the secure CAP communication between the first AP and the second AP is generated in accordance with information indicated via the one or more public key frames.

Aspect 14: The method of any of aspects 11 through 13, where transmitting the one or more frames includes: transmitting, as part of a handshake procedure between the first AP and the second AP, one or more CAP negotiation frames, one or more CAP notification frames, one or more CAP advertisement frames, or any combination thereof including one or more CAP management fields that indicate information associated with generation of the security key for the secure CAP communication between the first AP and the second AP, where transmitting the secure CAP communication is in accordance with the handshake procedure and the security key.

Aspect 15: The method of any of aspects 11 through 12, where transmitting the one or more frames includes: transmitting, in accordance with a PASN protocol, one or more PASN frames to the first AP, where the security key for the secure CAP communication between the first AP and the second AP is generated in accordance with information indicated via the one or more PASN frames.

Aspect 16: The method of any of aspects 11 through 12, where transmitting the one or more frames includes: transmitting, to the first AP and one or more other APs via the one or more frames, the security key including a CAP group key for secure group CAP transmissions by the second AP, where the secure CAP communication includes a group CAP communication to the first AP and the one or more other APs, and the security information is generated in accordance with the CAP group key.

Aspect 17: The method of any of aspects 11 through 16, further including: generating, in accordance with a plurality of fields included before a MIC field in the secure CAP communication and in accordance with the security key, a MIC; and transmitting the MIC via the MIC field in the secure CAP communication, where the security information includes the MIC.

Aspect 18: The method of any of aspects 11 through 16, further including: encrypting, before transmitting the secure CAP communication, the secure CAP communication in accordance with the security key, where the security information included in the secure CAP communication includes information encrypted in accordance with the security key.

Aspect 19: The method of any of aspects 11 through 18, where transmitting the secure CAP communication includes: transmitting a frame associated with in-BSS communications and the CAP communications, the frame including a protection indication that indicates whether the security information applies to the CAP communications or not, where verification, by the first AP, of the secure CAP communication, is performed in accordance with the protection indication.

Aspect 20: The method of any of aspects 11 through 19, where transmitting the secure CAP communication includes: transmitting, via the secure CAP communication, one or more first fields that convey the security information for verifying a first portion of the secure CAP communication; and transmitting, via the secure CAP communication, one or more second fields that convey second security information for verifying a second portion of the secure CAP communication including in-BSS communications by the second AP.

Aspect 21: A first AP for wireless communications, including at least one means for performing a method of any of aspects 1 through 10.

Aspect 22: A non-transitory computer-readable medium storing code for wireless communications, the code including instructions executable by one or more processors to perform a method of any of aspects 1 through 10.

Aspect 23: A second AP for wireless communications, including at least one means for performing a method of any of aspects 11 through 20.

Aspect 24: A non-transitory computer-readable medium storing code for wireless communications, the code including instructions executable by one or more processors to perform a method of any of aspects 11 through 20.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub-combination. As such, although features may be described above as acting in particular combinations, and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all implementations, and it should be understood that the described program components and systems can generally be integrated together in a single software product or packaged into multiple software products.

1. A first access point (AP), comprising:
a processing system that includes processor circuitry and memory circuitry that stores code, the processing system configured to cause the first AP to:
transmit a message that requests or indicates support for establishing coordinated AP (CAP) communications between the first AP and a second AP that is associated with a second basic service set (BSS) different from a first BSS of the first AP, wherein the message indicates at least one of an ability to establish a secure CAP communication across BSSs or one or more first security parameters for securing the CAP communications across BSSs;
receive one or more frames in accordance with the message and at least one of the ability to establish the secure CAP communication across BSSs or the one or more first security parameters, wherein the one or more frames indicate one or more second security parameters or a security key for the secure CAP communication between the first AP and the second AP; and
receive the secure CAP communication in accordance with security information that is associated with the security key, the security key being established between the first AP and the second AP according to the one or more frames and the one or more first and second security parameters.

2. The first AP of claim 1, wherein, to transmit the message, the processing system is configured to cause the first AP to:
transmit the message that indicates the one or more first security parameters, wherein the one or more first security parameters indicate, for each CAP communication scheme of one or more CAP communication schemes supported by the first AP, a respective security scheme supported by the first AP, and wherein the respective security scheme is one of a pairwise key establishment, a group key establishment, a message integrity protection, a message encryption, or any combination thereof.

3. The first AP of claim 1, wherein, to receive the one or more frames, the processing system is configured to cause the first AP to:
receive, in accordance with an AP PeerKey protocol, one or more public key frames from the second AP, wherein the security key for the secure CAP communication between the first AP and the second AP is generated in accordance with information indicated via the one or more public key frames.

4. The first AP of claim 1, wherein, to receive the one or more frames, the processing system is configured to cause the first AP to:
receive, as part of a handshake procedure between the first AP and the second AP, one or more CAP negotiation frames, one or more CAP notification frames, one or more CAP advertisement frames, or any combination thereof comprising one or more CAP management fields that indicate information associated with generation of the security key for the secure CAP communication between the first AP and the second AP, wherein receiving the secure CAP communication is in accordance with the handshake procedure and the security key.

5. The first AP of claim 1, wherein, to receive the one or more frames, the processing system is configured to cause the first AP to:
receive, in accordance with a pre-association security negotiation (PASN) protocol, one or more PASN frames from the second AP, wherein the security key for the secure CAP communication between the first AP and the second AP is generated in accordance with information indicated via the one or more PASN frames.

6. The first AP of claim 1, wherein:
the security key comprises a CAP group key for secure group CAP transmissions by the second AP to the first AP and one or more other APs;
the secure CAP communication comprises a group CAP communication; and
the security information is generated in accordance with the CAP group key.

7. The first AP of claim 1, wherein the processing system is further configured to cause the first AP to:
generate, in accordance with a plurality of fields included before a message integrity check (MIC) field in the secure CAP communication and in accordance with the security key, a first MIC, and
compare the first MIC with a second MIC indicated via the MIC field, wherein the security information comprises the second MIC.

8. The first AP of claim 1, wherein the processing system is further configured to cause the first AP to:
decrypt the secure CAP communication in accordance with the security key, wherein the security information included in the secure CAP communication comprises information encrypted in accordance with the security key.

9. The first AP of claim 1, wherein, to receive the secure CAP communication, the processing system is configured to cause the first AP to:
receive a frame associated with in-BSS communications and the CAP communications, the frame comprising a protection indication that indicates whether the security information applies to the CAP communications or not, wherein verification, by the first AP, of the secure CAP communication, is performed in accordance with the protection indication.

10. The first AP of claim 1, wherein, to receive the secure CAP communication, the processing system is configured to cause the first AP to:
receive, via the secure CAP communication, one or more first fields that convey the security information for verifying a first portion of the secure CAP communication directed to the first AP; and
receive, via the secure CAP communication, one or more second fields that convey second security information for verifying a second portion of the secure CAP communication comprising in-BSS communications by the second AP.

11. A second access point (AP), comprising:
a processing system that includes processor circuitry and memory circuitry that stores code, the processing system configured to cause the second AP to:
receive a message that requests or indicates support for establishing coordinated AP (CAP) communications between the second AP and a first AP that is associated with a first basic service set (BSS) different from a second BSS of the second AP, wherein the message indicates at least one of an ability to establish secure CAP communications across BSSs or one or more first security parameters for securing the CAP communications across BSSs;
transmit one or more frames in accordance with the message and at least one of the ability to establish the secure CAP communications across BSSs or the one or more first security parameters, wherein the one or more frames indicate one or more second security parameters or a security key for the secure CAP communication between the first AP and the second AP; and
transmit the secure CAP communication in accordance with security information that is associated with the security key, the security key being established between the first AP and the second AP according to the one or more frames and the one or more security parameters.

12. The second AP of claim 11, wherein, to receive the message, the processing system is configured to cause the second AP to:
receive a message that indicates the one or more first security parameters, wherein the one or more security parameters indicate one or more CAP communication schemes supported by the first AP and indicate, for each CAP communication scheme of the one or more CAP communication schemes supported by the first AP, a respective security scheme supported by the first AP, and wherein the respective security scheme is one of a pairwise key establishment, a group key establishment, a message integrity protection, a message encryption, or any combination thereof.

13. The second AP of claim 11, wherein, to transmit the one or more frames, the processing system is configured to cause the second AP to:
transmit, in accordance with an AP PeerKey protocol, one or more public key frames to the first AP, wherein the security key for the secure CAP communication between the first AP and the second AP is generated in accordance with information indicated via the one or more public key frames.

14. The second AP of claim 11, wherein, to transmit the one or more frames, the processing system is configured to cause the second AP to:
transmit, as part of a handshake procedure between the first AP and the second AP, one or more CAP negotiation frames, one or more CAP notification frames, one or more CAP advertisement frames, or any combination thereof comprising one or more CAP management fields that indicate information associated with generation of the security key for the secure CAP communication between the first AP and the second AP, wherein transmitting the secure CAP communication is in accordance with the handshake procedure and the security key.

15. The second AP of claim 11, wherein, to transmit the one or more frames, the processing system is configured to cause the second AP to:
transmit, in accordance with a pre-association security negotiation (PASN) protocol, one or more PASN frames to the first AP, wherein the security key for the secure CAP communication between the first AP and the second AP is generated in accordance with information indicated via the one or more PASN frames.

16. The second AP of claim 11, wherein, to transmit the one or more frames, the processing system is configured to cause the second AP to:
transmit, to the first AP and one or more other APs via the one or more frames, the security key comprising a CAP group key for secure group CAP transmissions by the second AP, wherein the secure CAP communication comprises a group CAP communication to the first AP and the one or more other APs, and the security information is generated in accordance with the CAP group key.

17. The second AP of claim 11, wherein the processing system is further configured to cause the second AP to:
generate, in accordance with a plurality of fields included before a message integrity check (MIC) field in the secure CAP communication and in accordance with the security key, a MIC; and
transmit the MIC via the MIC field in the secure CAP communication, wherein the security information comprises the MIC.

18. The second AP of claim 11, wherein the processing system is further configured to cause the second AP to:
encrypt, before transmitting the secure CAP communication, the secure CAP communication in accordance with the security key, wherein the security information included in the secure CAP communication comprises information encrypted in accordance with the security key.

19. The second AP of claim 11, wherein, to transmit the secure CAP communication, the processing system is configured to cause the second AP to:
transmit a frame associated with in-BSS communications and the CAP communications, the frame comprising a protection indication that indicates whether the security information applies to the CAP communications or not, wherein verification, by the first AP, of the secure CAP communication, is performed in accordance with the protection indication.

20. The second AP of claim 11, wherein, to transmit the secure CAP communication, the processing system is configured to cause the second AP to:
transmit, via the secure CAP communication, one or more first fields that convey the security information for verifying a first portion of the secure CAP communication; and
transmit, via the secure CAP communication, one or more second fields that convey second security information for verifying a second portion of the secure CAP communication comprising in-BSS communications by the second AP.

21. A method for wireless communications by a first access point (AP), comprising:
transmitting a message that requests or indicates support for establishing coordinated AP (CAP) communications between the first AP and a second AP that is associated with a second basic service set (BSS) different from a first BSS of the first AP, wherein the message indicates at least one of an ability to establish a secure CAP communication across BSSs or one or more first security parameters for securing the CAP communications across BSSs;
receiving one or more frames in accordance with the message and at least one of the ability to establish the secure CAP communication across BSSs or the one or more first security parameters, wherein the one or more frames indicate one or more second security parameters or a security key for the secure CAP communication between the first AP and the second AP; and
receiving the secure CAP communication in accordance with security information that is associated with the security key, the security key being established between the first AP and the second AP according to the one or more frames and the one or more first and second security parameters.

22. The method of claim 21, wherein transmitting the message comprises:
transmitting the message that indicates the one or more first security parameters, wherein the one or more first security parameters indicate, for each CAP communication scheme of one or more CAP communication schemes supported by the first AP, a respective security scheme supported by the first AP, and wherein the respective security scheme is one of a pairwise key establishment, a group key establishment, a message integrity protection, a message encryption, or any combination thereof.

23-26. (canceled)

27. The method of claim 21, further comprising:
generating, in accordance with a plurality of fields included before a message integrity check (MIC) field in the secure CAP communication and in accordance with the security key, a first MIC; and
comparing the first MIC with a second MIC indicated via the MIC field, wherein the security information comprises the second MIC.

28. The method of claim 21, further comprising:
decrypting the secure CAP communication in accordance with the security key, wherein the security information included in the secure CAP communication comprises information encrypted in accordance with the security key.

29. The method of claim 21, wherein receiving the secure CAP communication comprises:
receiving a frame associated with in-BSS communications and the CAP communications, the frame comprising a protection indication that indicates whether the security information applies to the CAP communications or not, wherein verification, by the first AP, of the secure CAP communication, is performed in accordance with the protection indication.

30. (canceled)

31. A method for wireless communications by a second access point (AP), comprising:
receiving a message that requests or indicates support for establishing coordinated AP (CAP) communications between the second AP and a first AP that is associated with a first basic service set (BSS) different from a second BSS of the second AP, wherein the message indicates at least one of an ability to establish secure CAP communications across BSSs or one or more first security parameters for securing the CAP communications across BSSs;
transmitting one or more frames in accordance with the message and at least one of the ability to establish the secure CAP communications across BSSs or the one or more first security parameters, wherein the one or more frames indicate one or more second security parameters or a security key for the secure CAP communication between the first AP and the second AP; and
transmitting the secure CAP communication in accordance with security information that is associated with the security key, the security key being established between the first AP and the second AP according to the one or more frames and the one or more security parameters.

32. (canceled)

33. The method of claim 31, wherein transmitting the one or more frames comprises:
transmitting, in accordance with an AP PeerKey protocol, one or more public key frames to the first AP, wherein the security key for the secure CAP communication between the first AP and the second AP is generated in accordance with information indicated via the one or more public key frames.

34. The method of claim 31, wherein transmitting the one or more frames comprises:
transmitting, as part of a handshake procedure between the first AP and the second AP, one or more CAP negotiation frames, one or more CAP notification frames, one or more CAP advertisement frames, or any combination thereof comprising one or more CAP management fields that indicate information associated with generation of the security key for the secure CAP communication between the first AP and the second AP, wherein transmitting the secure CAP communication is in accordance with the handshake procedure and the security key.

35. The method of claim 31, wherein transmitting the one or more frames comprises:
transmitting, in accordance with a pre-association security negotiation (PASN) protocol, one or more PASN frames to the first AP, wherein the security key for the secure CAP communication between the first AP and the second AP is generated in accordance with information indicated via the one or more PASN frames.

36. The method of claim 31, wherein transmitting the one or more frames comprises:
transmitting, to the first AP and one or more other APs via the one or more frames, the security key comprising a CAP group key for secure group CAP transmissions by the second AP, wherein the secure CAP communication comprises a group CAP communication to the first AP and the one or more other APs, and the security information is generated in accordance with the CAP group key.

37-40. (canceled)
